(19) United States
(12) Patent Application Publication
(10) Pub. No.: US 2012/0324363 A1
(43) Pub. Date: Dec. 20, 2012

(54) CONSUMER-GENERATED MEDIA INFLUENCE AND SENTIMENT DETERMINATION

(75) Inventors: Miles WARD, Des Moines, WA (US); James WEBBER, Puyallup, WA (US); Dean M. GRAZIANO, Mill Creek, WA (US)

(73) Assignee: VISIBLE TECHNOLOGIES INC., Bellevue, WA (US)

(21) Appl. No.: 13/596,897

(22) Filed: Aug. 28, 2012

Related U.S. Application Data
(63) Continuation of application No. 12/192,919, filed on Aug. 15, 2008.
Application No. 12/192,919 is a continuation-in-part of application No. 11/745,390, filed on May 7, 2007, now Pat. No. 7,720,835.
Application No. 11/745,390 is a continuation-in-part of application No. PCT/US2007/068392, filed on May 7, 2007.
(60) Provisional application No. 60/965,067, filed on Aug. 15, 2007.
(60) Provisional application No. 60/956,097, filed on Aug. 15, 2007.
(60) Provisional application No. 60/998,730, filed on Oct. 11, 2007.
(60) Provisional application No. 61/003,144, filed on Nov. 13, 2007.
(60) Provisional application No. 61/072,776, filed on Apr. 1, 2008.
(60) Provisional application No. 60/746,621, filed on May 5, 2006.
(60) Provisional application No. 60/861,406, filed on Nov. 27, 2006.
(60) Provisional application No. 60/903,810, filed on Feb. 26, 2007.

(51) Int. Cl. G06F 3/048; G06F 15/16

(52) U.S. Cl. 715/738

(57) ABSTRACT

A method implementable in at least one electronic device coupled to a network and a display device, includes receiving, over the network, a data set, receiving, from a user, a selection of a first topic, determining, based on the data set, a plurality of network sites hosting commentary of the first topic and an authority level of each site of the plurality, determining, based on the data set, an authority level of each site of the plurality, determining, based on the data set, a plurality of authors providing the commentary hosted by the plurality of network sites, determining, based on the data set, an authority level of each author of the plurality, and determining, based on the data set, a value characterizing an opinion of each author on the first topic.

### PRIORITY CLAIM

This application is a continuation of U.S. patent application Ser. No. 12/192,919 filed Aug. 15, 2008, which claims the benefit of U.S. Provisional Application Ser. No. 60/965,067 filed Aug. 15, 2007, U.S. Provisional Application Ser. No. 60/956,097 filed Aug. 15, 2007, U.S. Provisional Application Ser. No. 60/998,730 filed Oct. 11, 2007, U.S. Provisional Application Ser. No. 61/003,144 filed Nov. 13, 2007, U.S. Provisional Application Ser. No. 61/072,776 filed Apr. 1, 2008, and U.S. Provisional Application Ser. No. 61/126,061 filed Apr. 29, 2008. U.S. patent application Ser. No. 12/192,919 is also a continuation-in-part of and claims priority to U.S. patent application Ser. No. 11/745,390 filed May 7, 2007, and PCT Application Serial Number PCT/US07/68392 filed May 7, 2007 both of which claims priority to and the benefit of U.S. Provisional Application Ser. No. 60/746,621 filed May 5, 2006, U.S. Provisional Application Ser. No. 60/861,406 filed Nov. 27, 2006, and U.S. Provisional Application Ser. No. 60/903,810 filed Feb. 26, 2007. Each of the aforementioned applications is hereby incorporated by reference in its entirety as if fully set forth herein.

### COPYRIGHT NOTICE

This disclosure is protected under United States and International Copyright Laws. © 2006-2008 Visible Technologies. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### BACKGROUND OF THE INVENTION

As used herein, the term “Consumer Generated Media” (hereinafter CGM) may be a phrase that describes a wide variety of Internet web pages or sites, which are sometimes individually labeled as web logs or “blogs”, mobile phone blogs or “mo-blogs”, video hosting blogs or “vlogs” or “vblogs”, forums, electronic discussion messages. Usenet, message boards. BBS emulating services, product review and discussion web sites, online retail sites that support customer comments, social networks, media repositories, audio and video sharing sites/networks and digital libraries. Private non-Internet information systems can host CGM content as well, via environments like Sharepoint, Wiki, Jira, CRM systems; ERP systems; and advertising systems. Other acronyms that describe this space are CCC (consumer created content), WSM (weblogs and social media), WOMM (Word of Mouth Media) or OWOM, (online word of mouth), and many others.

As used herein, the term “Keyphrase” may refer to a word, string of words, or groups of words with Boolean modifiers that are used as models for discovering CGM content that might be relevant to a given topic, Could also be an example image, audio file or video file that has characteristics that would be used for content discovery and matching.

As used herein, the term “Post” may refer to a single piece of CGM content. This might be a literal weblog posting, a comment, a forum reply, a product review, or any other single element of CGM content.

As used herein, the term “Site” may refer to an Internet site which contains CGM content.

As used herein, the term “Blog” may refer to an Internet site which contains CGM content.

As used herein, the term “Content” may refer to media that resides on CGM sites, CGM is often text, but includes audio files and streams (podcasts, mp3, streamcasts, Internet radio, etc.) video files and streams, animations (flash, java) and other forms of multimedia.

As used herein, the term “UI” may refer to a User Interface, that users interact with computer software, perform work, and review results.

As used herein, the term “IM” may refer to an Instant Messenger, which is a class of software applications that allow direct text based communication between known peers.

As used herein, the term “Thread” may refer to an “original” post and all of the comments connected to it, present on a blog or forum. A discussion thread holds the information of content display order, so this message came first, followed by this, followed by this.

As used herein, the term “Permalink” may refer to a URL which persistently points to an individual CGM thread

The Internet and other computer networks are communication systems. The sophistication of this communication has improved and the primary modes differentiated over time and technological progress. Each primary mode of online communication varies based on a combination of three basic values: privacy and persistence and control, Email as a communications medium is private (communications are initially exchanged only between named recipients), persistent (saved in inboxes or mail servers) but lacks control (once you send the message, you can't take it back, or edit it, or limit re-use of it), Instant messaging is private, typically not persistent (some newer clients are now allowing users to save history, so this mode is changing) and lacks control. Message boards are public (typically all members, and often all Internet users, can access your message) persistent, but lack control (they are typically moderated by a central owner of the board). Chat rooms are public (again, some are membership based) typically not persistent, and lack control.

| | privacy | persistence | author control |
|---|---|---|---|
| Chat Rooms/IRC | no | no | no |
| Instant Messaging | yes | no | no |
| Forums | no | yes | no |
| Email | yes | yes | no |
| Blogs | no | yes | yes |
| social networks | yes/no | yes | yes |
| Second Life | yes | yes | yes+ |

Blogs and Social Networks are the predominant communications mediums that permit author control. By reducing the cost, technical sophistication, and experience required to create and administer a web site. Wogs and other persistent online communication have given an unprecedented amount of editorial control to millions of online authors. This has created a unique new environment for creative expression, commentary, discourse, and criticism without the historical limits of editorial control, cost, technical expertise, or distribution/exposure.

There is significant value in the information contained within this public media. Because the opinions, topics of discussion, brands and celebrities mentioned and relationships evinced are typically totally unsolicited, the information presented, if well studied, represents an amazing new source of social insight, consumer feedback, opinion measurement, popularity analysis and messaging data. It also represents a fully exposed, granular network of peer and hierarchical relationships rich with authority and influence. The marketing, advertising, and PR value of this information is unprecedented.

This new medium represents a significant challenge for interested parties to comprehensively understand and interact with. As of Q1 2007 estimates for the number of active, unique online CGM sites (forums, blogs, social networks, etc.) range from 50 to 71 million, with growth rates in the hundreds of thousands of new sites per day. Compared to the typical mediums that PR, Advertising and Marketing businesses and divisions interact with (<1000 TV channels, <1000 radio stations, <1000 major news publications, <10-20 major pundits on any given subject, etc.) this represents a nearly 10,000-fold increase in the number of potential targets for interaction.

Businesses and other motivated communicators have come to depend on software that perform Business Intelligence, Customer Relationship Management, and Enterprise Resource Planning tasks to facilitate accelerated, organized, prioritized, tracked and analyzed interaction with customers and other target groups (voters, consumers, pundits, opinion leaders, analysts, reporters, etc.). These systems have been extended to facilitate IM, E-mail, and telephone interactions. These media have been successfully integrated because of standards (jabber, pop3, smtp, pots, imap) that require that all participant applications conform to a set data format that allows interaction with this data in a predictable way.

Blogs and other CGM generate business value for their owners, both on private sites that use custom or open source software to manage their communications, and for massive public hosts. Because these sites can generate advertising revenue, there is a drive by author/owners to protect the content on these sites, so readers/subscribers/peers have to visit the site, and become exposed to revenue generating advertising, in order to participate in/observe the communication. Because of this financial disincentive, there is no unifying standard for blogs which contains complete data. RSS and Atom feeds allow structured communication of some portion of the communication on sites, but are often very incomplete representations of the data available on a given site. Sites also protect their content from being “stolen” by automated systems with an array of CAPTCHAs, (“Completely Automated Public Turing test to tell Computers and Humans Apart”) email verification, mobile phone text message verification, password authentication, cookie tracking, Uniform Resource Locator (URL) obfuscation, timeouts and Internet Protocol (IF) address tracking.

The result is a massively diverse community that it would be very valuable to understand and interact with, which resists aggregation and unified interaction by way of significant technical diversity, resistance to complete information data standards, and tests that attempt to require one-to-one human interaction with content.

### BRIEF DESCRIPTION OF THE DRAWINGS

The preferred and alternative embodiments of the present invention are described in detail below with reference to the following drawings.

FIGS. 1-2 shows an exemplary system for consumer generated media reputation management according to an embodiment;

FIG. 3 shows a system for consumer generated media influence and sentiment determination according to an embodiment of the invention;

FIG. 4 illustrates an authority map according to an embodiment of the invention;

FIG. 5 illustrates a feature of an authority map according to an embodiment of the invention; and

FIGS. 6-9 illustrate authority map features according to embodiments of the invention.

### DETAILED DESCRIPTION OF THE PREFERRED EMBODIMENT

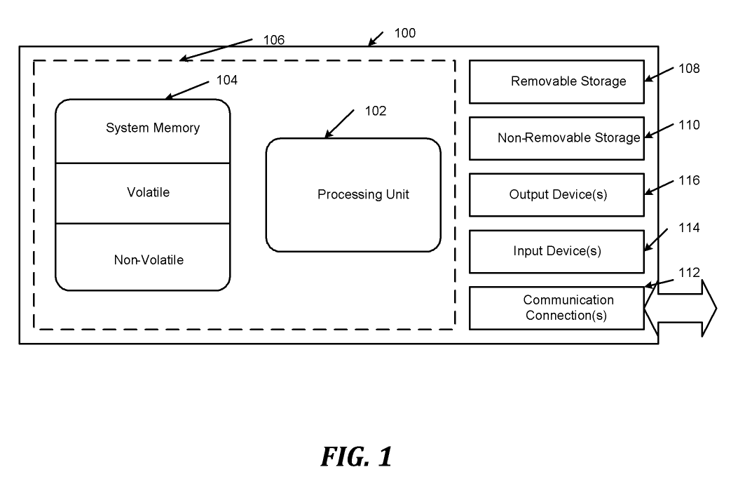

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of embodiments of the invention. Neither should the computing environment 100 be interpreted as having any dependency or requirement relating to any one or combination of components illustrated in the exemplary operating environment 100.

Embodiments of the invention are operational with numerous other general-purpose or special-purpose computing-system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed-computing environments that include any of the above systems or devices, and the like.

Embodiments of the invention may be described, in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed-computing environment, program modules may be located in both local- and remote-computer storage media including memory storage devices.

With reference to FIG. 1, an exemplary system for implementing an embodiment of the invention includes a computing device, such as computing device 100. In its most basic configuration, computing device 100 typically includes at least one processing unit 102 and memory 104.

Depending on the exact configuration and type of computing device, memory 104 may be volatile (such as random-access memory (RAM)), non-volatile (such as read-only memory (ROM), flash memory, etc.) or some combination of the two. This most basic configuration is illustrated in FIG. 1 by dashed line 106.

Additionally, device 100 may have additional features/functionality. For example, device 100 may also include additional storage (removable and/or non-removable) including, but not limited to, magnetic or optical disks or tape. Such additional storage is illustrated, in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 100 may also have input device(s) 114 such as keyboard, mouse, pen, voice-input device, touch-input device, etc. Output device(s) 116 such as a display, speakers, printer, etc. may also be included. All such devices are well-known in the art and need not be discussed at length here.

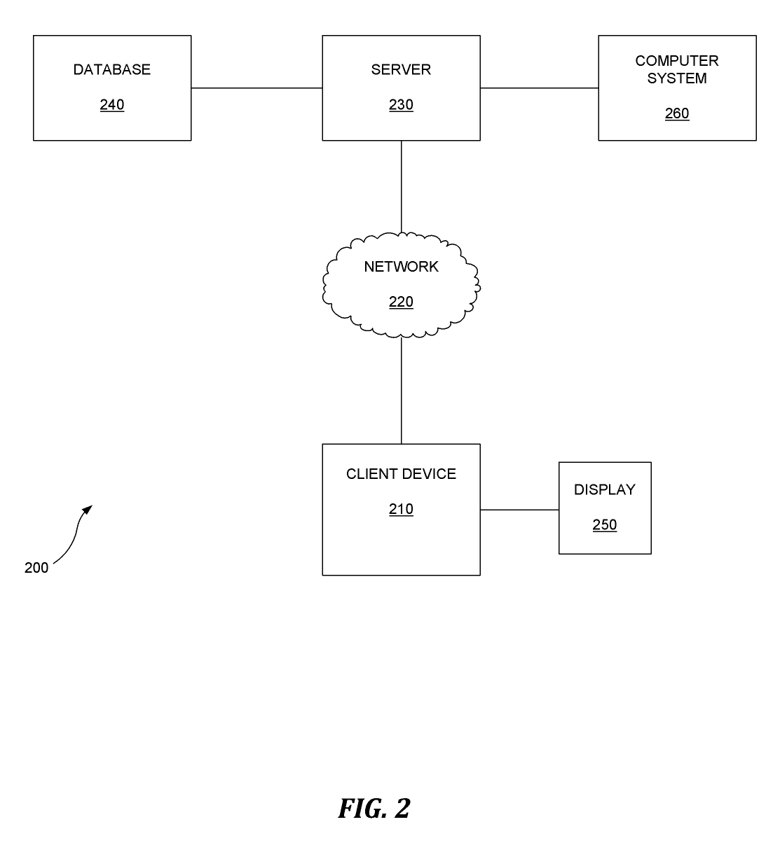

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the device 100 illustrated in and discussed with reference to FIG. 1. Client device 210 includes or is otherwise coupled to a computer screen or display 250. As is well known in the art, client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

In at least one embodiment, methods and systems are implemented by a coordinated software and hardware computer system. This system may include a set of dedicated networked servers controlled by an embodiment. The servers may be installed with a combination of commercially available software, custom configurations, and custom software. A web server is one of those modules, which exposes a web based client-side UI to customer web browsers. The UI interacts with the dedicated servers to deliver information to users. The cumulative logical function of these systems results in a system and method of an embodiment.

In alternate embodiments, the servers could be placed client side, could be shared or publicly owned, could be located together or separately. The servers could be the aggregation of non-dedicated compute resources from a Peer to Peer (P2P), grid, or other distributed network computing environments. The servers could run different commercial applications, different configurations with the same or similar cumulative logical function. The client to this system could be run directly from the server, could be a client side executable, could reside on a mobile phone or mobile media device, could be a plug-in to other Line of Business applications or management systems. This system could operate in a client-less mode where only Application Programming interface (API) or eXtensible Markup Language (XML) or Web-Services or other formatted network connections are made directly to the server system. These outside consumers could be installed on the same servers as the custom application components. The custom server-side engine applications could be written in different languages, using different constructs, foundations, architectural methodologies, storage and processing behaviors while retaining the same or similar cumulative logical function. The UI could be built in different languages, using different constructs, foundations, architectural methodologies, storage and processing behaviors while retaining the same or similar cumulative logical function.

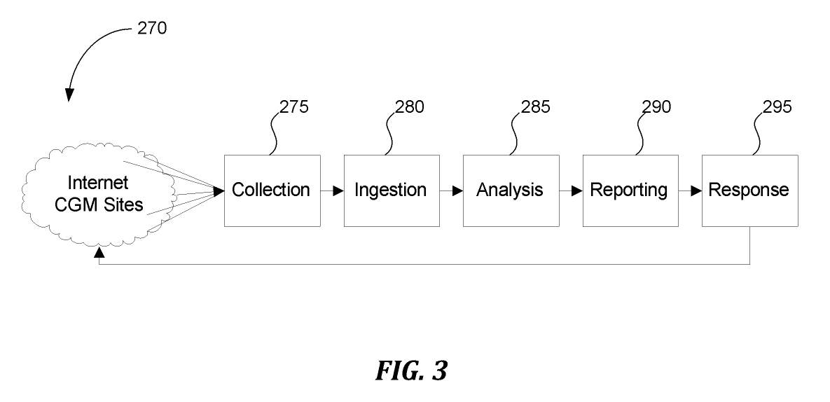

FIG. 3 shows a system within which may be implemented a method for consumer-generated media influence and sentiment determination. The system can be broken down into a set of modules. The modules may be, but are not limited to, the following: collection module 275 that receives data from Internet CGM sites 270, ingestion module 280, analysis module 285, reporting module 290 and response module 295, which may provided feedback data back to sites 270, as are described in greater detail below herein.

Embodiments of the invention may be described in the context of one or more ecosystems. An “ecosystem” in the context of the present application may describe online personas and locations (sites) of their interactions that can be further described by how the interactions occur, the topics of those interactions, the frequency of interactions, etc. The authority map is a way to visualize the lame and interconnected network of the web by helping reduce the size and scope of such an ecosystem to a consumable format.

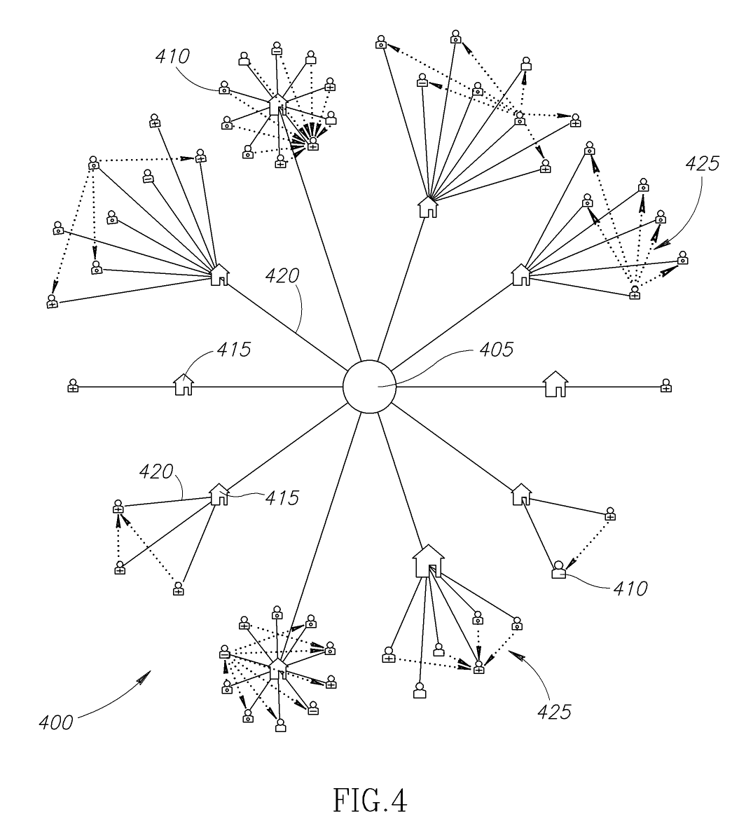

In an embodiment, and referring now to FIG. 4, an authority map 400 is illustrated, which may be displayed within a graphical user interface 401 on the display device 250. The authority map 400 is a tool for identifying and understanding the authors, associated with a specified topic of interest, that matter to a particular entity using such an embodiment. In the illustrated embodiment, the displayed map 400 shows an icon 405 representing a topic being analyzed, which, as illustrated, may be displayed as a hub of a hub-and-spoke configuration, along with a textual description of the topic. Also displayed are icons 410 representing authors of varying levels of authority or perceived influence (discussed in greater detail below herein) who have commented or otherwise posted an opinion on the displayed topic. These icons 410 may further include a domain identifier associated with the author, as illustrated. Also displayed are icons 415 representing sites of varying levels of authority or perceived influence (discussed in greater detail below herein) hosting conversations involving those authors and the displayed topic. These icons 415 may further include a domain identifier associated with the site, as illustrated.

In an embodiment, each of the icons 410, 415 may be presented in a distinguishing format to indicate varying levels of authority/influence, and/or prevailing opinion or sentiment on the topic, associated with authors and sites. For example, size of the icons 410, 415 may correspond to authority/influence of the respective author or site: bigger for more authoritative, smaller for less authoritative. Color, shading or pattern type of the icons 410, 415 may correspond to prevailing sentiment (e.g., green for positive, red for negative, grey for neutral, and orange for mixed). Lines 420 connect the icons 410 of authors to the icons 415 of sites that host them, and from the site icons to the topic icon 405 at the center. Dotted (or other distinguishing) lines 425 represent conversations or other connections occurring between authors. In an embodiment, arrows at the ends of the dotted lines 425 show the direction of interaction, pointing, for example, from commenter to original post author.

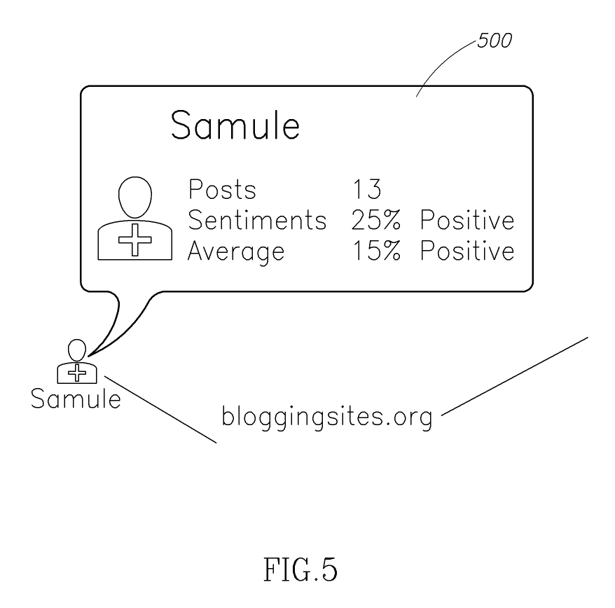

To populate the map 400, a criteria panel (not shown), such a pull-down menu, for example, may be used to select the topic of interest. The interface 401 allows a user to get additional information about any of the nodes (icons associated with authors, sites, and topics) on the display 401. For example, and referring to FIG. 5, by left clicking on a node, a small pop-up window 500 with additional detail about that node will appear. The display allows one to promote or “pin” nodes that are of interest, which makes those items larger on the screen. Items may be pinned by clicking on the upper right hand side of the node icon.

Further included within an embodiment of the authority map is a series of calculations. For example, in an embodiment, the magnitude of author authority may be calculated based on data representing the topic selected by the user, using the conversations between authors and the activity generated by the commentary of a particular author (e.g., the number of comments posted in response to a comment by the author) to evaluate the author's authority. This data may be calculated or otherwise determined computationally/automatically (i.e., by execution of computer-executable instructions), by human analysis, or some combination of both types of approaches.

The magnitude of site authority may be defined or otherwise determined in a manner similar to that used to determine the magnitude of as author authority. Data representing content pertaining to a particular topic may be determined to have been written or otherwise produced by someone at a site. As such, sites having associated therewith a predetermined threshold number of comments pertaining to a particular topic may be determined to be an authoritative site. The magnitude of the authority of these sites may then be determined based on, for example, the amount or volume of comment pertaining to the topic in question and associated with each respective site. This data may be calculated or otherwise determined computationally/automatically (i.e., by execution of computer-executable instructions), by human analysis, or some combination both types of approaches.

Sentiment may be calculated by a weighted metric on the overall sentiment distribution, which favors “sentimented” values over neutral values four to one. This ensures that a user is seeing which way an author leans when writing on a topic. Counts and totals are reflective of the on-topic conversations based on the topic of interest chosen; if an author has written 200 posts, but only 5 are about the topic you're researching, the calculations will only leverage the 5 within the calculation. The result is that the user can set the context in order to identify authorities in relation to that context.

Further included within an embodiment of the authority map is a series of calculations. As raw data comes in from collection, the data is processed and analyzed in several ways. Each unique post or comment is first matched to one or more topics of interest leveraging term-based definitions. For each topic matched, a sentiment is assigned using either manual attribution or computational attribution. Computational attribution of sentiment is achieved using technology that correlates patterns between a set of known pieces of content that represent the sentiment for a topic to the individual piece of content being analyzed. For example, an embodiment uses text parsing in conjunction with Bayesian inference in order to assign a probability that a post exists within each of a neutral or sentimented “states.” Each state is represented by a definition derived from groups of posts that are characteristic of that state. The comparison is done using the state definitions that are stored in an index resident on the client device 210 and/or server 230 and/or database 240 and comparing that state definition with the con tent in question. Alternatively, or additionally, an embodiment uses keyword/keyphrase/keysentence recognition in conjunction with an index, for example, that correlates a sentiment value with a particular or group of keyword/keyphrase/keysentence to determine an author's opinion on a topic.

When displaying an author or site's sentiment in the Authority Map, the dominant sentiment is calculated by a weighted metric on the overall sentiment distribution across all posts that match the topic being analyzed, weighting “sentimented” values over neutral values in a 4:1 ratio. For authors, the posts not only match the topic, but have also been written by the author of interest. For sites, the posts not only match the topic, but have also been written at the site of interest. Authority is then calculated based on the data representing the topic selected by the user, using the conversations between authors and the activity (post counts) to evaluate the author's (or site's) Authority. Therefore, calculations are reflective of the on-topic conversations, computed relative to the topic ecosystem being analyzed; if an author has written 200 posts, but only 5 are about the topic you're researching, the calculations will only leverage the 5 within the calculation. The result is that the user can set the context in order to identify authorities in relation to that context.

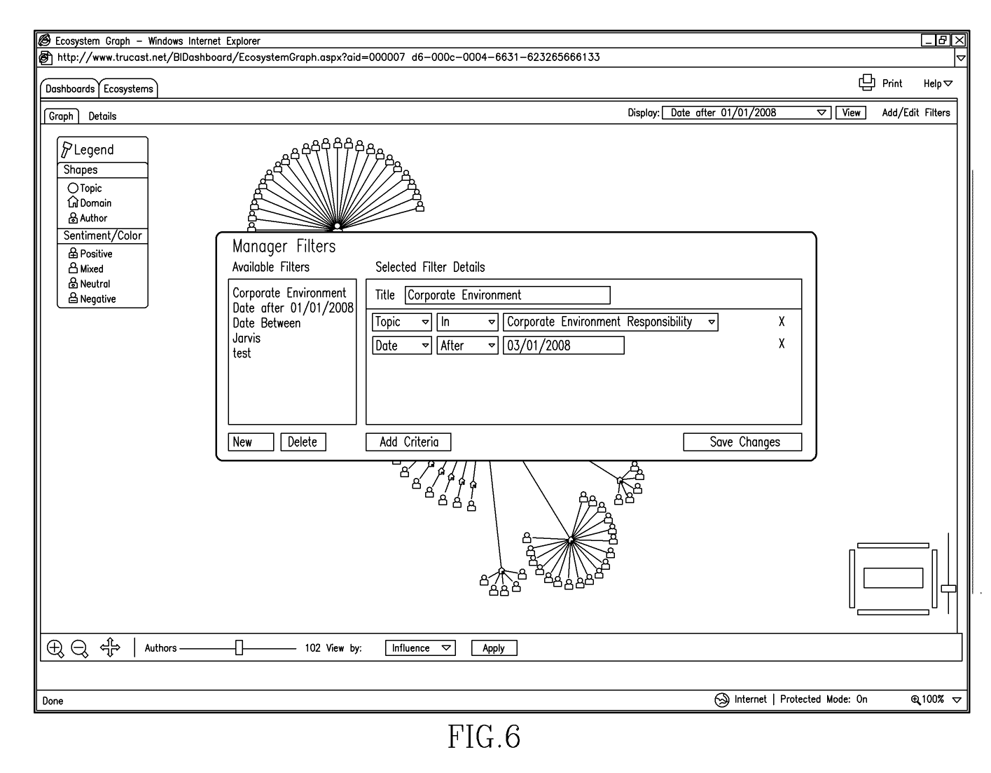

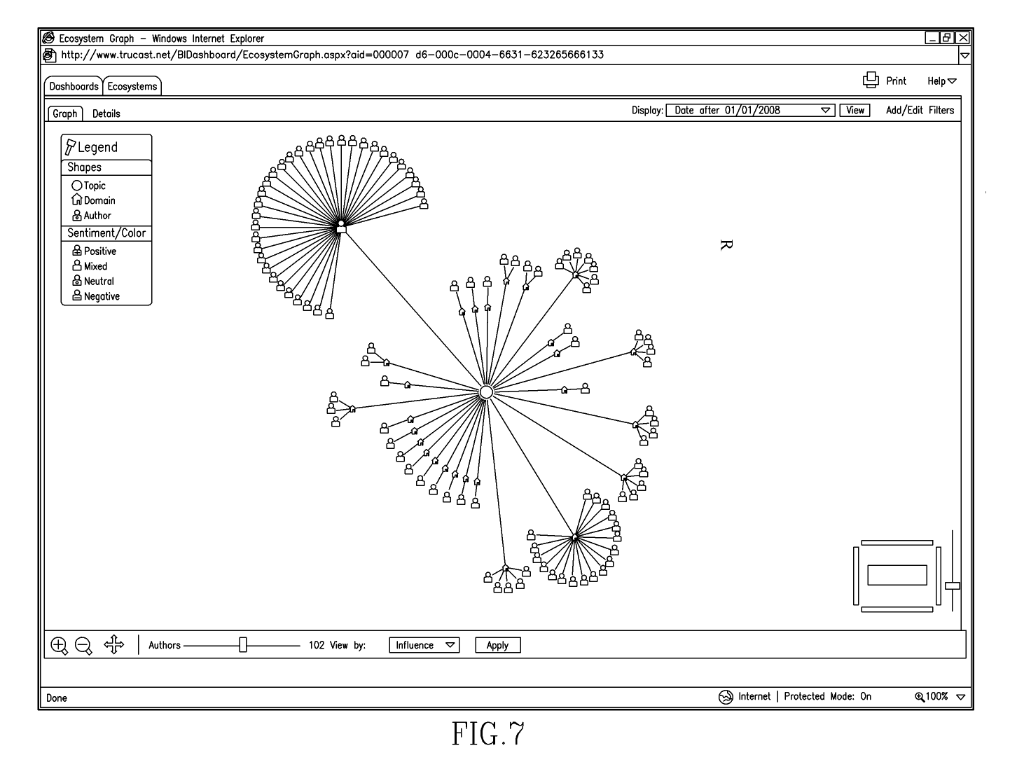

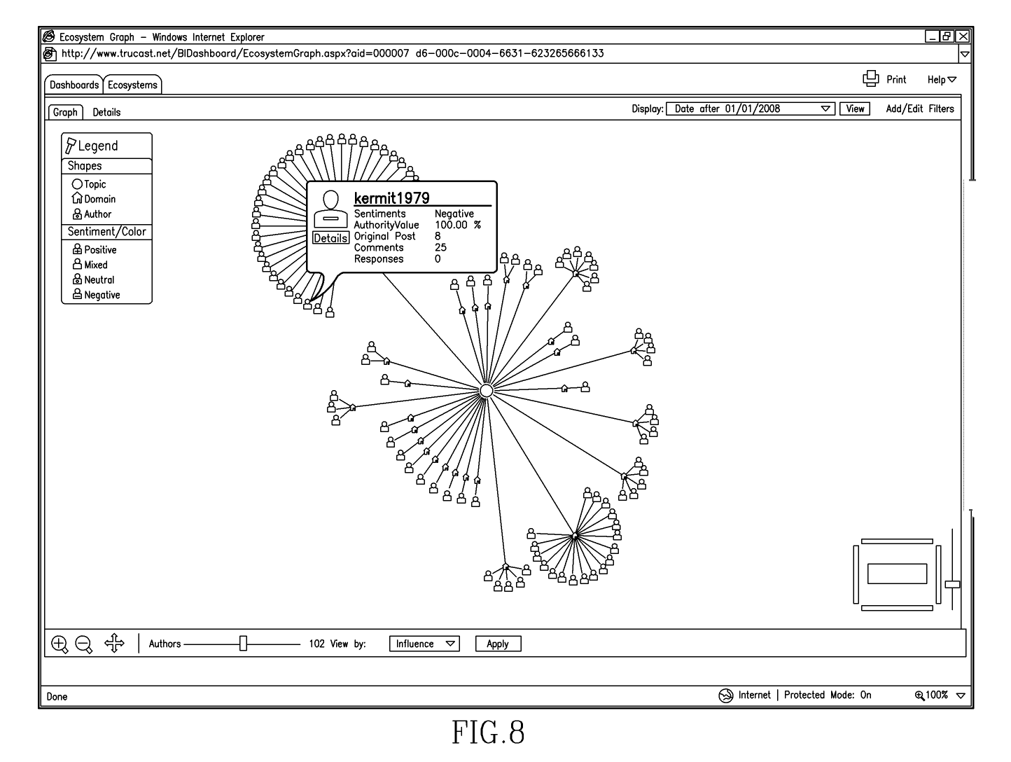

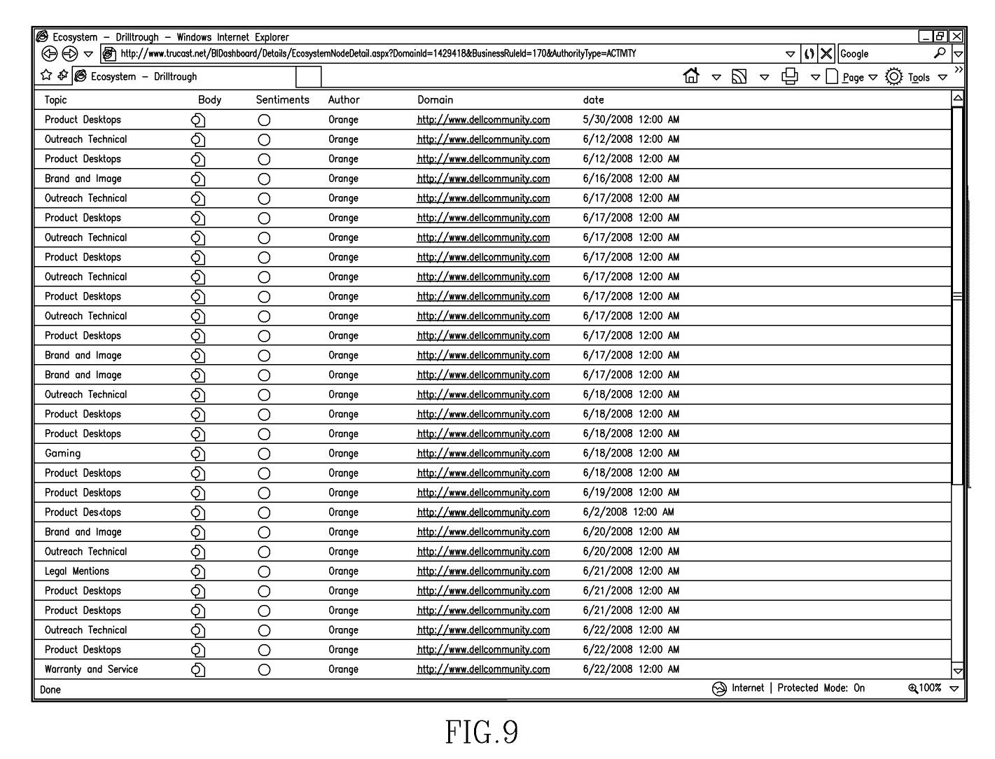

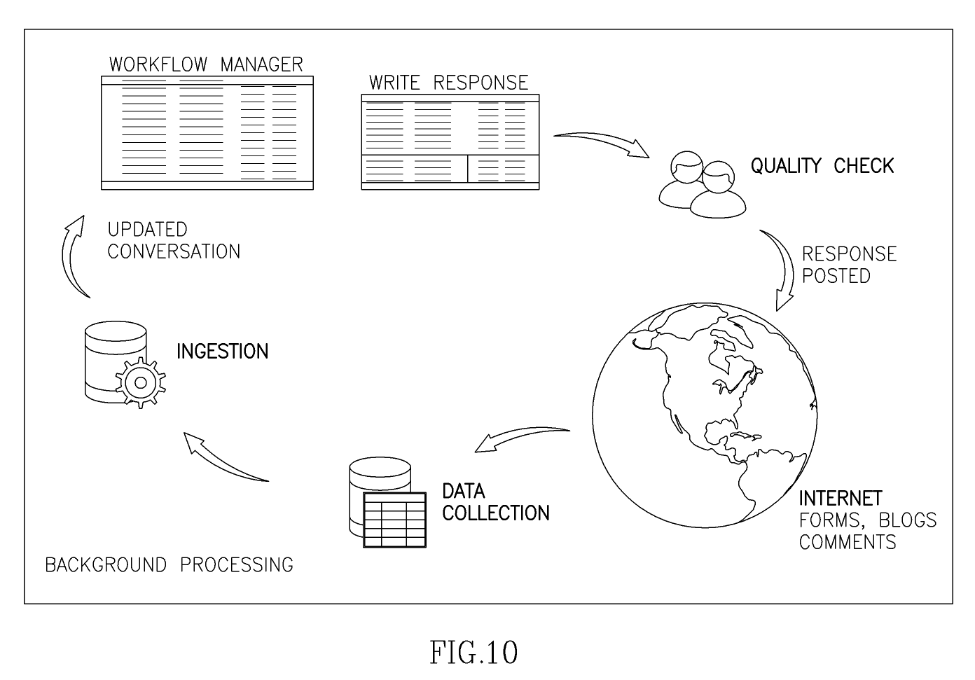

Referring to FIGS. 6-9, embodiments of an authority map include but are not limited to the following features:

Single topic representation with a topic selector for context

Color-coded sentiment visualization rolled up to Authors and Sites

Authority represented by icon size

Topic-Site linkage

Site-Author linkage

Author-Author linkage

Mouse-over tool tip with data stats

Alternative embodiments may include:
Sliding scale to allow user to choose the number of authors displayed
Date and Site Domain Filters
Data Drill down capabilities that allows users to view the data behind the calculations
3 different authority calculations
Activity (Overall volumes of content)
Pull (Unique Inbound Authors)

Inbound authors are those that comment on a given author's original post
Reach (Unique Outbound Authors)

Outbound authors are those that given author has commented on
Mini map navigation tool
Zoom navigation
Landscape panning
Graph versus List View
3 new authority calculations
Authorship (Volume of Original Posts)
Participation (Volume of Commentary)
Influence (Weighted metric of Activity, Pull and Reach)

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method implementable in at least one electronic device coupled to a network and a display device, the method comprising the steps of:
receiving, over the network, a data set;
generating to the display device a graphical user interface (GUI) including a menu of topics selectable by a user of the GUI;
receiving, from the user, a selection of a first topic of the menu;
determining, based on the data set, a plurality of network sites hosting commentary on the first topic; and
determining, based on the data set, an authority level of each site of the plurality of network sites.

2. The method of claim 1, further comprising determining, based on the data set, a plurality of authors providing the commentary hosted by the plurality of network sites.

3. The method of claim 2, further comprising determining, based on the data set, an authority level of each author of the plurality of authors.

4. The method of claim 2, further comprising determining, based on the data set, a value characterizing an opinion on the first topic of each author of the plurality of authors.

5. The method of claim 1, further comprising, in response to the user selection, generating within the GUI a set of icons representing the plurality of sites, the icons being presented in multiple presentation formats based on the determined authority levels.

6. The method of claim 4, further comprising, in response to the user selection, generating within the GUI a set of icons representing the plurality of authors, the icons being presented in multiple presentation formats based on the determined opinion values.

7. A method implementable in at least one electronic device coupled to a network and a display device, the method comprising the steps of:
receiving, over the network, a data set;
generating to the display device a graphical user interface (GUI) including a menu of topics selectable by a user of the GUI;
receiving, from the user, a selection of a first topic of the menu;
determining, based on the data set, a plurality of network sites hosting commentary on the first topic; and
in response to the user selection, generating within the GUI a set of icons representing the plurality of sites.

8. The method of claim 7, further comprising determining, based on the data set, an authority level of each site of the plurality of network sites, wherein the icons are presented in multiple different presentation formats, each presentation format indicating a respective one of the determined authority levels.

9. The method of claim 7, further comprising determining, based on the data set, a plurality of authors providing the commentary hosted by the plurality of network sites; and
in response to the user selection, generating within the GUI a set of icons representing the plurality of authors.

10. The method of claim 9, further comprising determining, based on the data set, an authority level of each author of the plurality of authors, wherein the icons are presented in multiple different presentation formats, each presentation format indicating a respective one of the determined authority levels.

11. The method of claim 9, further comprising determining, based on the data set, a value characterizing an opinion of each author on the first topic, wherein the icons are presented in multiple different presentation formats, each presentation format indicating a respective one of the determined opinion values.

12. The method of claim 9, further comprising determining the existence of a communication between a first author of the plurality of authors and a second author of the plurality of authors

13. The method of claim 12, further comprising, in response to determining the existence of the communication, generating within the GUI at least one object graphically connecting a first icon representing the first author to a second icon representing the second author.

14. The method of claim 13, wherein the at least one object graphically depicts the direction of interaction between the first author and the second author.
